(19) United States
(12) Patent Application Publication
(10) Pub. No.: US 2008/0226050 A1
(43) Pub. Date: Sep. 18, 2008

(54) SYSTEM AND METHOD FOR ESTABLISHING CONFERENCE EVENTS

(75) Inventors: Arto Leppisaari, Kangasala (FI); Eva-Maria Leppanen, Lempaala (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/687,610

(22) Filed: Mar. 16, 2007

(51) Int. Cl. H04M 3/42; H04L 12/18; H04M 3/56

(52) U.S. Cl. 379/202.01; 370/260; 370/261; 455/416

(57) ABSTRACT

A system and method for providing additional information to conference participants with regard to a predefined conference event such as scheduled conference. In various embodiments, outgoing conference indications include an identifier that indicates to a recipient that the conference invitation is being sent due to the occurrence of a scheduled event and/or due to the occurrence of other conditions being met.

### FIELD OF THE INVENTION

The present invention relates generally to conferencing services and similar group communication services. More particularly, the present invention relates to the establishing of conferences that have been previously scheduled or conferences that meet certain criteria.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Session Initiation Protocol (SIP) is an application-layer control protocol for creating, modifying, and terminating sessions with one or more participants. These sessions may include Internet telephone calls, multimedia distribution, and conferences including voice, video and messaging conferences. In addition to SIP conferencing, the Open Mobile Alliance (OMA) has defined an XML Document Management (XDM) enabler for pre-defined groups or conferences. XDM allows for the storing of pre-defined groups, such as member lists, group policies, etc. within the network.

One special type of conferencing service is a scheduled conference. In a scheduled conference, group definitions that are stored within the network include information about the date and time at which the conference will be initiated by the conference server. At the designated date and time, the conference server initiates the conference by inviting conference members (as defined in the group/conference definitions) to join the conference. Conferences can also be scheduled using other systems. One such system is the iCalendar system over SIP. iCalendar specifies a calendar object presentation format that is used to provide and deploy interoperable calendaring and scheduling services. iCalendar is discussed in detail in the Internet Engineering Task Force (IETF) Request for Comments No. 2445, which can be found at “www.ietf.org/rfc/rfc2445.txt” and is incorporated herein by reference.

When a scheduled conference is created and stored within a network unit such as a XDMS server, conference participants can be notified about the scheduled event. This notification can be provided in several manners. For example, one method of notifying participants involves sending an iCalendar-formatted calendar request to each participant. Other types of corresponding requests may also be sent. When sending these requests, either the SIP protocol, the XCAP protocol, or a protocol of another type may be used. In the case of an iCalendar-formatted calendar event, this event will contain a date and time for the scheduled conference, the subject of the conference, a participant list, and other information about the conference. Additionally, an iCalendar-formatted calendar event may also include a unique identifier (UID) that is used to uniquely identify the event.

When the designated date and time for the scheduled conference has been reached, the conference server, for example a push-to-talk-over-cellular (PoC) server, is triggered in order to establish the conference, and the conference server invites participants to join the conference. The actual invitation can take the form of a SIP INVITE message which contains the uniform resource identifier (URI) of the conference (i.e., the Group URI). The Group URI is used by the invited participant to identify that the invitation emanated from a certain pre-defined group.

It should be noted that the procedure described above is applicable for both scheduled conferences and other pre-defined conferences that are triggered when certain circumstances are met. For example, such a procedure can be used for pre-defined conferences which are set to be established when a certain number of conference participants are registered to the network. In such a situation, a conference server evaluates the criteria and, when the criteria is met, the conference is established.

Although the information provided by conference server invitations is helpful to a recipient, there is additional information that would be helpful that is not made available by the conference server. For example, there is currently no mechanism defined to identify and indicate to the recipient that the invitation is related to a certain scheduled event of the group, i.e., no indication is provided that indicates the specific scheduled calendar appointment to which the invitation refers. It would therefore be desirable to provide such information to conference participants.

### SUMMARY OF THE INVENTION

Various embodiments of the present invention provide a system and method for providing additional information to a conference participant with regard to a scheduled conference or other pre-defined conference. In various embodiments, outgoing conference indications include a unique identifier that indicates to a recipient that the conference invitation is being sent due to the occurrence of a certain event, such as a previously-scheduled calendar appointment or certain criteria (such as when a certain number of conference participants are registered to the network) are met. With these various embodiments, an invited conference participant is capable of identifying that a conference invitation is related specifically to a previously sent scheduled calendar event or other types of pre-defined conditions. At the same time, the payload of the conference invitation is not unnecessarily increased, as only the unique identifier value is sent to the user. The various embodiments of the present invention may be implemented on systems regardless of how the scheduled conference is initially created.

Various embodiments of the present invention can be applied to a variety of conference types, including but not limited to, scheduled conferences. For example, certain embodiments of the present invention can be applied to situations where a client creates a conference event that is established when certain conditions are fulfilled, for example based upon the availability and/or location of the participants.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a diagram showing an implementation of the present invention when using a SIP mechanism;

FIG. 2 is a diagram showing an implementation of the present invention when using a XDM;

FIG. 3 is a perspective view of an electronic device that can be used in conjunction with the implementation of various embodiments of the present invention; and

FIG. 4 is a schematic representation of the circuitry which may be included in the electronic device of FIG. 3.

### DETAILED DESCRIPTION OF VARIOUS EMBODIMENTS

Various embodiments of the present invention provide a system and method for providing additional information to a conference participant with regard to a scheduled conference. In various embodiments, outgoing conference indications include a unique identifier that indicates to a recipient that the conference invitation is being sent due to the occurrence of a scheduled or other conditionally established event.

In various embodiments of the present invention, iCalendar is used to describe calendar events. iCalendar specifies the UID property as a unique calendar identifier in the following manner:

Property Name: UID

Purpose: This property defines the persistent, globally unique identifier for the calendar component.

Value Type: TEXT

Example: The following is an example of this property:

UID:19960401T080045Z-4000F192713-0052@host1.com

It is generally assumed that, prior to the occurrence of a scheduled conference event, invited participants have received a notification about the scheduled event or other conditionally established event, e.g., through the use of a received iCalendar event (including the UID). The iCalendar event can be sent, for example, as part of a Group Advertisement (using the OMA PoC and OMA instant messaging (IM) feature), via calendar synchronizations, etc. Alternatively, the server may only be sent a link to the calendar information.

According to various embodiments of the present invention, when the scheduled date and time for the scheduled conference is met (or when other conditions for the conference event are met), and upon conference server initiating the conference, a SIP INVITE message is sent to the intended participants. It should be noted that other types of messages, such as SIP UPDATE or SIP REFER messages, may also be used. However, an SIP INVITE message is used herein as an example. The SIP INVITE message contains the iCalendar UID, another type of unique identifier, or a link to detailed information (e.g., a link to calendar information) in a Call-Info header field as follows:

INVITE sip:bob@biloxi.com SIP/2.0

Via: SIP/2.0/UDP pc33.atlanta.com;branch=z9hG4bK776asdhds

To: Bob <sip:bob@biloxi.com>

From: Alice <sip: alice@atlanta.com>;tag=1928301774

Call-ID: a84b4c76e66710 pc33.atlanta.com

Call-Info: 19960401T080045Z-4000F192713-0052 host1.com;purpose=info

CSeq: 314159 INVITE

Contact: <sip:alice@pc33.atlanta.com>

Content-Type: application/sdp

Content-Length: 142

When an invited client device receives the SIP INVITE request, the client device can use the UID value contained in the Call-Info field to associate the invitation with the scheduled event or other conditionally established event.

With regard to the Call-Info header, the IETF's Request for Comments 3261 (which can be found at “www.ietf.org/rfc/rfc3261.txt” and is incorporated herein by reference) specifies “icon”, “info” and “card” values for the “Purpose” parameter of the Call-Info header. In one particular embodiment of the present invention, the “info” value is used when the Call-Info header indicates that the conference invitation is being sent due to the occurrence of a scheduled event. In other embodiments of the invention, an entirely new purpose value may be used other than those discussed above. Additionally, it is also possible to use a SIP header other than the Call-Info header in order to carry the conference event identification.

A number of options exist for transporting the identifier for the outgoing conference invitation. A first option involves the use of iCalendar. The IETF's Request for Comments 2445 (which can be found at “www.ietf.org/rfc/rfc2445.txt” and is incorporated herein by reference) includes its own Multipurpose Internet Mail Extensions (MIME) type “text/calendar” for iCalendar events. As such, an iCalendar-formatted document (including the UID) can be included into an INVITE request as an additional payload.

A second option for transporting the identifier involves the use of a Globally Routable User Agent URI (GRUU). The IETF draft “draft-ietf-sip-gruu-11.txt” (which can be found at www.ietforg/internet-drafts/draft-ietf-sip-gruu-11.txt and is incorporated herein by reference) specifies the GRUU as a globally unique SIP UA identifier. The GRUU is formed from the URI by adding a unique “gr” attribute in the end of the URI. Because a pre-defined group stored in XDMS is identified with a group URI, the GRUU can be used to uniquely identify different instances of the group. One such instance of the group can be a conference event that is established when certain conditions are met (e.g., date and time, availability of the participants, etc.). When a scheduled conference event is created by using a pre-defined group, an XDMS server needs to allocate a GRUU for the newly created conference instance. The GRUU can be obtained by generating it locally or by requesting it as part of a REGISTER procedure. In this particular case, XDMS generates the public GRUU locally. The following is an example of a GRUU:

sip:golf-team@example.com;gr=kjh29x97us97d

The GRUU is sent to the participants of the scheduled conference event, for example as part of a Group Advertisement request or in an iCalendar calendar event. When the conference event is initiated, the conference server includes the GRUU in the Contact header or other appropriate header (e.g., From, P-Asserted-ID or a header where Service-identity type of information is placed in the future) of an outgoing INVITE request in the following form:

INVITE sip:bob@biloxi.com SIP/2.0

Via: SIP/2.0/UDP pc33.atlanta.com;branch=z9hG4bK776asdhds

To: Bob <sip:bob@biloxi.com>

From: Golf-Team <sip:golf-team atlanta.com>

Call-ID: a84b4c76e66710pc33.atlanta.com

CSeq: 314159 INVITE

Contact: sip:golf-team@example.com;gr=kjh29x97us97d

Content-Type: application/sdp

Content-Length: 142

Upon receiving the above INVITE request, an invited client can associate the scheduled event and received invitation by using the GRUU.

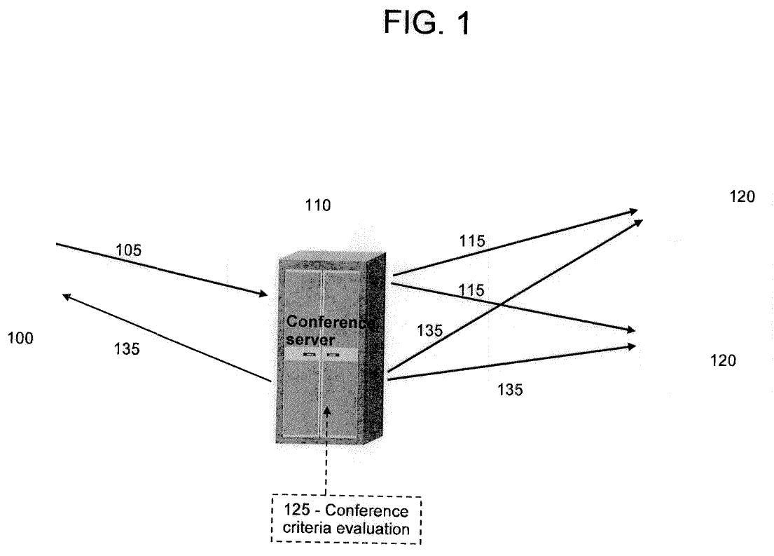

FIG. 1 is a diagram showing an implementation of the present invention when using a SIP mechanism. As shown in FIG. 1, a client device, referred to herein as a creating device 100, is capable of creating a scheduled conference or other conditionally established event by communicating with a conference server 110 at 105. The communication from the creating device 100 to the conference server 110 can occur, for example, using iCalendar over SIP. Once the scheduled conference has been created, the conference server 110 sends a notification about the scheduled conference at 115 to other client devices 120 whom the creating device has requested should be invited to the scheduled conference. These notifications can be transmitted in the form of an iCalendar UID, GRUU, etc. and transported via a specifically formatted SIP request by using OMA-specified group advertisements or another relevant transport mechanisms. At 125, the conference server 110 proceeds to evaluate the pre-defined conditions for establishing an conference, e.g., whether the conditions for the conference has been reached. Once the conditions for conference establishment have been reached, the conference server 110 proceeds to send a conference invitation at 135 to the creating device 100 and to the other client devices 120. The conference invitation can be included in a SIP message (e.g., SIP INVITE, SIP UPDATE or SIP REFER messages) with the information pertaining to the conference event, (e.g., in the form of an iCalendar UID, iCalendar payload or GRUU). As discussed previously, this process can apply both to scheduled conferences (in which case it is determined at 125 whether the date and time for the conference has been reached), and conferences meeting other pre-defined criteria, such as when a predetermined number of individuals become available.

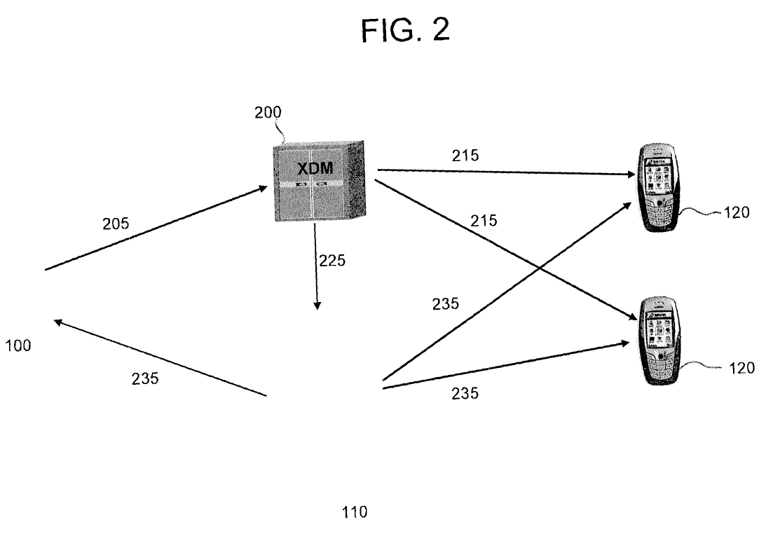

FIG. 2 is a diagram showing an implementation of the present invention when using an XDM 200. At 205 in FIG. 2, the creating device 100 creates a scheduled conference (or other type of conditionally established conference) with the XDM 200. At 215, the XDM 200 sends a notification about the scheduled conference (or other type of conditionally established conference) to the other client devices 120. These notifications can be transmitted using an iCalendar UID, GRUU, etc. At 225, when the scheduled date and time for the conference has been reached, the XDM 200 informs the conference server 110. The conference server then proceeds to send a conference invitation at 235 to the creating device 100 and to the other client devices 120. The conference invitation is included in an INVITE message with the information pertaining to the conference event, (e.g., in the form of an iCalendar UID, iCalendar payload or GRUU).

Communication devices implementing various embodiments of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

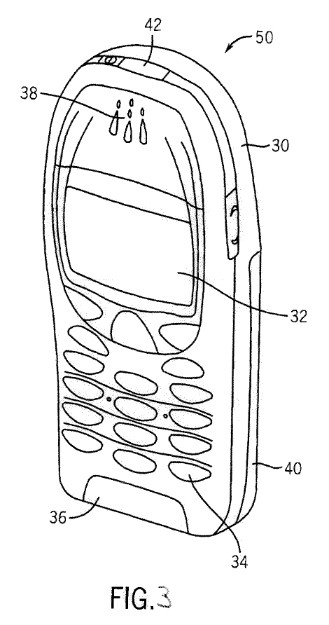

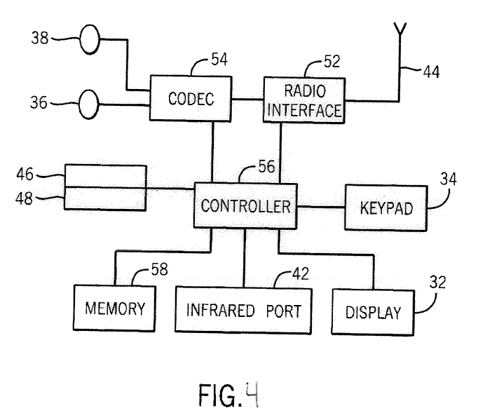

FIGS. 3 and 4 show one representative electronic device 50 within which the present invention may be implemented. It should be understood, however, that the present invention is not intended to be limited to one particular type of device. The electronic device 50 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The various embodiments of the present invention described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

Individual and specific structures described in the foregoing examples should be understood as constituting representative structure of means for performing specific functions described in the following the claims, although limitations in the claims should not be interpreted as constituting “means plus function” limitations in the event that the term “means” is not used therein. Additionally, the use of the term “step” in the foregoing description should not be used to construe any specific limitation in the claims as constituting a “step plus function” limitation. To the extent that individual references, including issued patents, patent applications, and non-patent publications, are described or otherwise mentioned herein, such references are not intended and should not be interpreted as limiting the scope of the following claims.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated.

What is claimed is:

1. A method of providing information to at least one device about a conference event, comprising:
determining whether at least one predefined condition for the initiation of the conference event has been met; and
if the at least one predefined condition for the conference event has been met, transmitting to the at least one device an invitation to join the conference event, the invitation including an indication that the invitation is related to the conference event.

2. The method of claim 1, wherein the conference event comprises a scheduled conference.

3. The method of claim 2, wherein the at least one predefined condition comprises a scheduled date and time for the conference event to begin.

4. The method of claim 1, wherein the at least one predefined condition comprises at least one of a condition related to the location of intended conference participants and a condition related to the availability of intended conference participants.

5. The method of claim 1, wherein the conference event comprises a specific scheduled calendar appointment.

6. The method of claim 1, wherein the indication is included in one of a Session Initiation Protocol (SIP) INVITE request, a SIP UPDATE request and a SIP REFER request.

7. The method of claim 6, wherein the indication comprises an iCalendar unique identifier value.

8. The method of claim 7, wherein the iCalendar unique identifier is included in a “Call-Info” header field of the respective SIP INVITE request, SIP UPDATE request, or SIP REFER request.

9. The method of claim 1, wherein the indication comprises a link to detailed information relating to the conference event.

10. The method of claim 1, wherein the indication is included in a Globally Routable User Agent Uniform Resource Identifier.

11. A computer program product, embodied in a computer-readable medium, comprising computer code for performing the processes of claim 1.

12. An apparatus, comprising:
a processor; and
a memory unit communicatively connected to the processor and including:
computer code for determining whether at least one predefined condition for the initiation of a conference event has been met; and
computer code for, if the at least one predefined condition for the conference event has been met, transmitting to the at least one device an invitation to join the conference event, the invitation including an indication that the invitation is related to the conference event.

13. The apparatus of claim 12, wherein the conference event comprises a scheduled conference.

14. The apparatus of claim 13, wherein the at least one predefined condition comprises a scheduled date and time for the conference event to begin.

15. The apparatus of claim 12, wherein the at least one predefined condition comprises at least one of a condition related to the location of intended conference participants and a condition related to the availability of intended conference participants.

16. The apparatus of claim 12, wherein the scheduled event comprises a specific scheduled calendar appointment.

17. The apparatus of claim 12, wherein the indication is included in one of a Session Initiation Protocol (SIP) INVITE request, a SIP UPDATE request and a SIP REFER request.

18. The apparatus of claim 17, wherein the indication comprises an iCalendar unique identifier value.

19. The apparatus of claim 18, wherein the iCalendar unique identifier is included in a “Call-Info” header field of the respective SIP INVITE request, SIP UPDATE request, or SIP REFER request.

20. The apparatus of claim 12, wherein the indication comprises a link to detailed information relating to the conference event.

21. The apparatus of claim 12, wherein the indication is included in a Globally Routable User Agent Uniform Resource Identifier.

22. A method of processing information about a conference event, comprising:
receiving an invitation to join the conference event from a conference server; and
processing an indication included within the invitation, the indication indicating that the invitation is related to the conference event.

23. The method of claim 22, wherein the conference event comprises a scheduled conference.

24. The method of claim 22, wherein the indication is included one of in a Session Initiation Protocol (SIP) INVITE request, a SIP UPDATE request and a SIP REFER request.

25. The method of claim 24, wherein the indication comprises an iCalendar unique identifier value.

26. The method of claim 25, wherein the iCalendar unique identifier is included in a “Call-Info” header field of respective the SIP INVITE request, SIP UPDATE request or SIP REFER request.

27. The method of claim 22, wherein the indication comprises a link to detailed information relating to the conference event.

28. The method of claim 22, wherein the indication is included in a Globally Routable User Agent Uniform Resource Identifier.

29. A computer program product, embodied in a computer-readable medium, comprising computer code for performing the processes of claim 22.

30. An apparatus, comprising:
a processor; and
a memory unit communicatively connected to the processor,
wherein the apparatus is configured to:
receive an invitation to join the conference event from a conference server; and
process an indication included within the invitation, the indication indicating that the invitation is related to the conference event.

31. The apparatus of claim 29, wherein the conference event comprises a scheduled conference.

32. The apparatus of claim 29, wherein the indication is included in one of a Session Initiation Protocol (SIP) INVITE request, a SIP UPDATE request and a SIP REFER request.

33. The apparatus of claim 31, wherein the indication comprises an iCalendar unique identifier value.

34. The apparatus of claim 32, wherein the iCalendar unique identifier is included in a “Call-Info” header field of the respective SIP INVITE request, SIP UPDATE request or SIP REFER request.

35. The apparatus of claim 29, wherein the indication is included in a Globally Routable User Agent Uniform Resource Identifier.
